(19) United States
(12) Patent Application Publication
(10) Pub. No.: US 2002/0143648 A1
(43) Pub. Date: Oct. 3, 2002

(54) Online shopping apparatus and method of performing communication with terminal storing unrewritable identification information

(75) Inventor: Hajime Nishimoto, Hyogo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Mitsubishi Denki Kabushiki Kaisha, Chiyoda-ku (JP)

(21) Appl. No.: 09/921,559

(22) Filed: Aug. 6, 2001

(30) Foreign Application Priority Data
Mar. 29, 2001 (JP) 2001-094757

(51) Int. Cl. G06F 17/60

(52) U.S. Cl. 705/26

(57) ABSTRACT

A mobile telephone stores unrewritable identification data for identifying its own hardware. A user enters order data specifying an article selected by the user for purchase into the mobile telephone. The mobile telephone reads out the identification information, and sends the identification data and the order data. An online shopping method includes the steps of preparing a name and an address of the user of the mobile telephone corresponding to the identification information, reading out the name and address of the user of the mobile telephone based on the identification data when the identification data and the order data are received from the mobile telephone, and sending the order data and the user's name and address to a computer of an online shopping dealer.

### BACKGROUND OF THE INVENTION

1. Field of the Invention

The present invention relates to an online shopping system, and particularly to a system, by which users can easily place orders for articles.

2. Description of the Background Art

Online shopping is generally performed as follows. A user selects an article(s) in a catalog, which is already distributed. The user places an order with an online shopping dealer for the selected article via telephone or facsimile. A shipping agent is requested to transport the article by the online shopping dealer, and transports the article to the user. The user pays the price of the article after receiving it. Japanese Patent Laying-Open No. 2000-357189 has disclosed an online shopping apparatus for use in the above kind of online shopping system.

This online shopping apparatus is used for placing an order with a dealer for an article over a communication line. This apparatus includes a bar code reading circuit for reading a bar code indicative of article order information from a catalog, a storage circuit for storing user information and a sending circuit, which is connected to a communication line for sending the article order information and the user information to the online shopping dealer.

According to the above apparatus, the article information, i.e., the information of the article, read from the bar code reading circuit and the user information already stored in the storage circuit are sent to the online shopping dealer. Since the article information is entered by reading the bar code, the user can easily select the article. Since the user information is stored in advance in the storage circuit, the user is not required to enter the user's name and address for each placement of the order. Therefore, the user can place an order extremely easily in the online shopping system.

According to the above apparatus, if a third party changes the address in the user' information into the address of the third party, the ordered article will be sent to the third party. Even in this case, the user, who does not receive the article, is charged for the price of the article.

### SUMMARY OF THE INVENTION

An object of the invention is to provide an online shopping apparatus and an online shopping method, which are protected from abuse and misuse by third parties.

Another object of the invention is to provide an online shopping apparatus and an online shopping method, which allow easy placement of an order in an online shopping system.

Still another object of the invention is to provide an online shopping apparatus and an online shopping method, which allow reliable placement of an order in an online shopping system.

Yet another object of the invention is to provide an online shopping apparatus and an online shopping method, which can protect privacy.

An online shopping apparatus according to the invention includes a communication circuit that communicates with a user's terminal and a terminal of an online shopping dealer. The user's terminal stores unrewritable identification information for identifying the user's terminal itself. The user's terminal reads out the identification information, and sends the identification information and article information representing an article selected for purchase to the online shopping apparatus when a user enters the article information. The online shopping apparatus further includes a storage circuit that stores in advance the identification information and stores in advance data indicative of a name of the user and data indicative of a destination designated by the user both corresponding to the identification information, a receiving circuit connected to the communication circuit that receives the article information and the identification information from the user's terminal, a retrieving circuit connected to the receiving circuit and the storage circuit that retrieves the stored data corresponding to the received identification information, a producing circuit connected to said retrieving circuit that produces the user's information for specifying the user's name and the designation based on the retrieved data, and a sending circuit connected to the communication circuit and the producing circuit that sends the article information and the produced user's information to the terminal of the online shopping dealer.

The user's terminal sends the unrewritable identification information for specifying the user's terminal itself and the article information to the online shopping apparatus. The identification information is an unrewritable ESN (electrical Serial Number), which specifies, e.g., the hardware itself of the user's terminal. This identification information is written in an electronic manner by a special device of a manufacturer of the user's terminal during manufacturing of the user's terminal. Once manufacturing of the user's terminal is completed, the unrewritable identification information described above forms information, which is extremely difficult for the manufacturer to rewrite. For third parties not having the special device other than the manufacturer, it is impossible to rewrite the unrewritable identification information described above. The unrewritable information described above includes information, which is extremely difficult to rewrite for the manufacturer, as well as information, which does not allow rewriting by the third parties other than the manufacturer.

When the receiving circuit receives the article information and the identification information from the user's terminal, the retrieving circuit retrieves the stored user's name and destination corresponding to the received identification information. The producing circuit produces the user's information for specifying the user's name and destination, and the sending circuit sends the article information and the produced user's information to the terminal of the online shopping dealer. When the user enters the article information into the user's terminal such as a mobile telephone, the entered article information and the ESN stored in the user's terminal are sent to the online shopping apparatus. The online shopping apparatus retrieves the user's name and destination, which are stored in advance and correspond to the ESN, and prepares the user information for sending them to the terminal of the online shopping dealer. The online shopping dealer performs processing for sending the article selected by the user to the destination based on the received article information and the user information. Since the user is not required to enter data such as a name, a destination and a user's code, the user can easily place an order for the article in the online shopping system. Abuse and misuse by the third parties can be prevented because the processing in the online shopping system is performed based on the data, which is stored in advance based on the unrewritable ESN.

More preferably, the online shopping apparatus includes a computing circuit that obtains a charge of communication to the user's terminal, a price storing circuit that stores data representing prices of the articles corresponding to the articles, and a calculating circuit connected to the computing circuit and the price storing circuit that adds the price of the article selected by the user to the communication charge, and calculates a sum of money charged to the user.

The calculating circuit calculates the sum of money to be charged to the user by adding the price of the article to the communication charge. The charged sum of money including the communication charge and the price of the article can be calculated.

More preferably, the online shopping apparatus may include a confirmation receiving circuit connected to the communication circuit that receives order confirmation information from the terminal of the online shopping dealer, and a confirmation sending circuit connected to the communication circuit that sends the order confirmation information to the user's terminal.

The order confirmation information sent from the terminal of the online shopping dealer is sent to the user's terminal. The user can confirm the reception of the order by the online shopping dealer.

More preferably, the online shopping apparatus may include a shipping agent communication circuit that communicates with a terminal of a shipping agent delivering the article to the user, and the user information sending circuit that sends the data indicating the name of the user and specified by the user information as well as the data indicating the destination and specified by the user information to the terminal of the shipping agent in response to the reception of user inquiry information.

The producing circuit produces information for specifying the retrieved user's name and destination, and particularly the user information such as a user code expressing the user's name and destination in the form, which is unrecognizable by the online shopping dealer and the shipping agent. The online shopping apparatus sends the produced user code to the terminal of the shipping agent. The shipping agent cannot identify the destination and name of the user from the user code, and therefore sends the user code to the online shopping apparatus. The user information sending circuit sends the destination and name of the user specified by the user code to the terminal of the shipping agent. The article can be delivered by the shipping agent without allowing recognition of the designation and name of the user by the shopping online dealer. Privacy can be protected, and the articles can be easily ordered in the online shopping system.

An online shopping method according to another aspect of the invention is a method for use by an online shopping apparatus performing communication between a user's terminal and a terminal of an online shopping dealer. The user's terminal stores unrewritable identification information for identifying the user's terminal itself. The user's terminal reads out the identification information, and sends the identification information and article information representing an article selected for purchase to the online shopping apparatus when a user enters the article information. The online shopping method includes the steps of preparing in advance the identification information, data representing a user's name and corresponding to the identification information, and data representing a destination designated by the user and corresponding to the identification information; receiving the article information and the identification information from the user's terminal; retrieving the data stored corresponding to the received identification information; preparing user information for specifying the user's name and destination based on the retrieved data; and sending the article information and the prepared user information to the terminal of the online shopping dealer.

The user's terminal sends the unrewritable ESN for specifying the user's terminal itself and the article information to the online shopping apparatus. According to the online shopping method, when the article information and the identification information are received from the user's terminal, a retrieving circuit retrieves the stored user's name and destination corresponding to the received identification information. According to the online shopping method, the user information for specifying the user's name and destination is prepared, and the article information and the user information thus prepared are sent to the terminal of the online shopping dealer. The online shopping dealer performs processing based on the received article information and the user information for delivering the article selected by the user.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows whole architecture of an online shopping system;

FIG. 2 shows an appearance of a computer implementing a server;

FIG. 3 is a control block diagram of a computer;

FIG. 4 is a control block diagram of a mobile telephone;

FIG. 5 shows a user database stored in a fixed disk of the server;

FIG. 6 shows an accounting database stored in the fixed disk of the server;

FIG. 7 shows order data sent from the mobile telephone to the server;

FIG. 8 shows transfer data sent from the server to the computer of the online shopping dealer;

FIG. 9 shows order confirmation data sent from the computer of the online shopping dealer to the server and sent from the server to the mobile telephone;

FIG. 10 shows order confirmation response data sent from the mobile telephone to the server and sent from the server to the computer of the online shopping dealer;

FIG. 11 shows delivery request data sent from the computer of the online shopping dealer to a computer of a shipping agent;

FIG. 12 shows delivery confirmation data sent from the computer of the shipping agent to the server and sent from the server to the mobile telephone;

FIG. 13 shows delivery confirmation response data sent from the mobile telephone to the server and sent from the server to the computer of the shipping agent;

FIG. 14 shows accounting request data sent from the computer of the online shopping dealer to the server;

FIG. 15 shows accounting data sent from the server to the mobile telephone;

FIG. 16 is a flowchart showing order processing in the server;

FIG. 17 is a flowchart showing order confirming processing in the server;

FIG. 18 is a flowchart showing delivery confirming processing in the server;

FIG. 19 is a flowchart showing charge calculating processing in the server;

FIG. 20 shows transfer data sent from the server to the computer of the online shopping dealer;

FIG. 21 shows delivery request data sent from the computer of the online shopping dealer to the computer of the shipping agent;

FIG. 22 shows user information inquiry data sent from the computer of the shipping agent to the server;

FIG. 23 shows user information response data sent from the server to the computer of the shipping agent;

FIG. 24 is a flowchart showing order receiving processing in the server; and

FIG. 25 is a flowchart showing user information response processing in the server.

### DESCRIPTION OF THE PREFERRED EMBODIMENTS

Embodiments of the invention will now be described with reference to the drawings. In the following description and drawings, the same parts bear the same reference numbers. The same parts bear the same names, and achieve the same functions. Therefore, description thereof is not repeated.

### First Embodiment

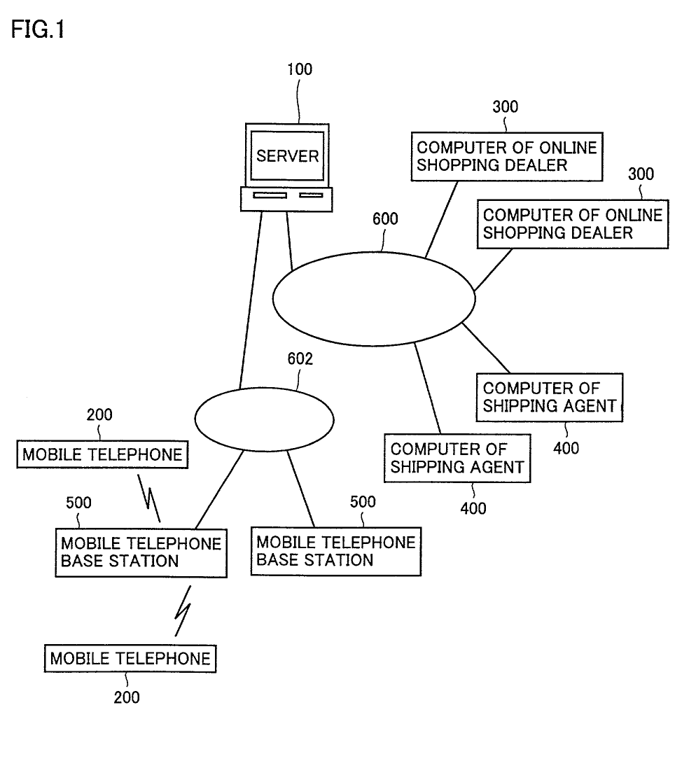

Referring to FIG. 1, the online shopping system of a first embodiment includes a mobile telephone 200 of a user utilizing the online shopping system, a computer 300 of an online shopping dealer, a computer 400 of a shipping agent delivering an article(s) to the user, and a server 100 which is connected over a network to computer 300 of the online shopping dealer and computer 400 of the shipping agent. Server 100 is connected to a base station 500 of the mobile telephone over a network 602.

The user who selected an article(s) for purchase enters article information (article code and quantity) for the selected article(s) into his/her mobile telephone 200 of a subscriber line, for which the user signed with a communication company of the mobile telephone. Mobile telephone 200 has stored identification information for specifying the hardware itself of the mobile telephone. Mobile telephone 200 sends the article information and the identification information to server 100 via base station 500. Based on the received identification information, server 100 retrieves the name and address of the user of mobile telephone 200 from the user database already stored therein. The name and address were provided by the user to the communication company when signed a contract for the subscriber line with the communication company of the mobile telephone. Server 100 prepares user information (the name and destination of the user), in which the retrieved address and name are handled as the destination and receiver, respectively. Server 100 sends the article information and user information to computer 300 of the online shopping dealer. As described above, server 100 achieves such an article ordering function in the online shopping system that user's information is prepared based on the information received from user's mobile telephone 200, and the article information and the user information are sent to the online shopping dealer.

In the online shopping system of this embodiment, the article ordering function of server 100 is achieved by executing a predetermined program by a CPU (Central Processing Unit) in the computer.

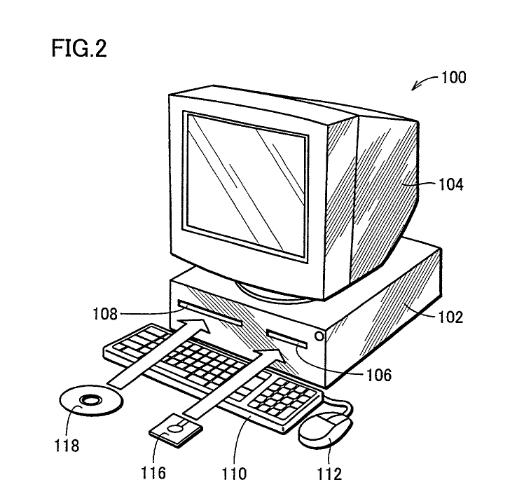

FIG. 2 shows an outer appearance of a computer system, which is an example of server 100 achieving the article ordering function. Referring to FIG. 2, the computer system includes a computer 102 provided with an FD (Flexible Disk) drive unit 106 and a CD-ROM (Compact Disc Read-Only Memory) drive unit 108, a monitor 104, a keyboard 110 and a mouse 112.

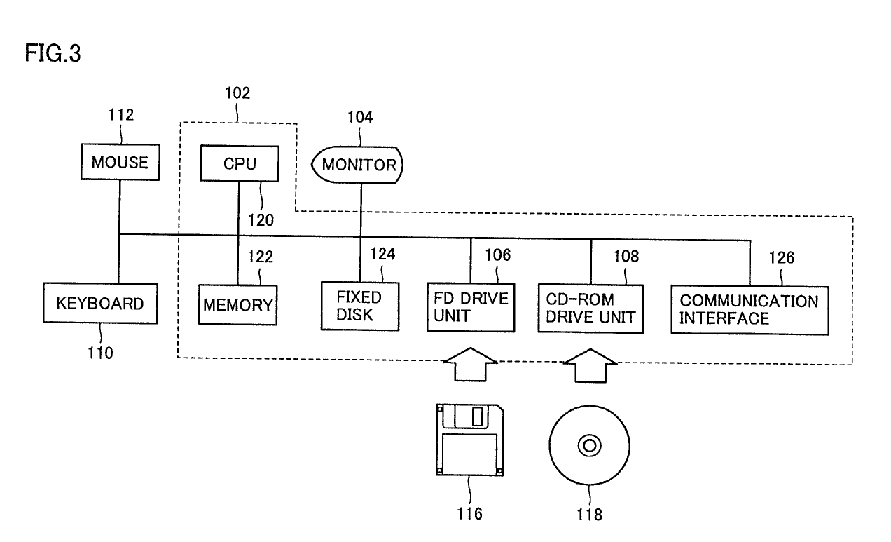

FIG. 3 is a block diagram showing architecture of the computer system. As shown in FIG. 3, computer 102 includes, in addition to FD drive unit 106 and CD-ROM drive unit 108, a CPU (Central Processing Unit) 120, a memory 122, a fixed disk 124 and a communication interface 126 for communication with other computers as well as a bus for mutually connecting these portions. An FD 116 is set in FD drive unit 106. A CD-ROM is set in CD-ROM drive unit 108. These FD 116 and CD-ROM 118 have stored predetermined programs.

As already described, server 100 having the article ordering function is achieved by the computer hardware and the program executed by CPU 120. In general, the above program has been stored in the record mediums such as FD 116 and CD-ROM 118 for distribution, and is read from the record medium by FD drive unit 106 or CD-ROM drive unit 108 for storage in fixed disk 124. Further, the program is read from fixed disk 124 into memory 122, and is executed by CPU 120.

The hardware itself of the computer is a general architecture. The computer includes a control circuit including the CPU, a storage circuit, an input circuit, an output circuit and an OS (Operating System), and thus satisfies system requirements for executing the program. The invention uses the computer for achieving the article ordering function in the online shopping system.

The operation itself of the computer shown in FIGS. 2 and 3 is well known, and therefore will not be described here.

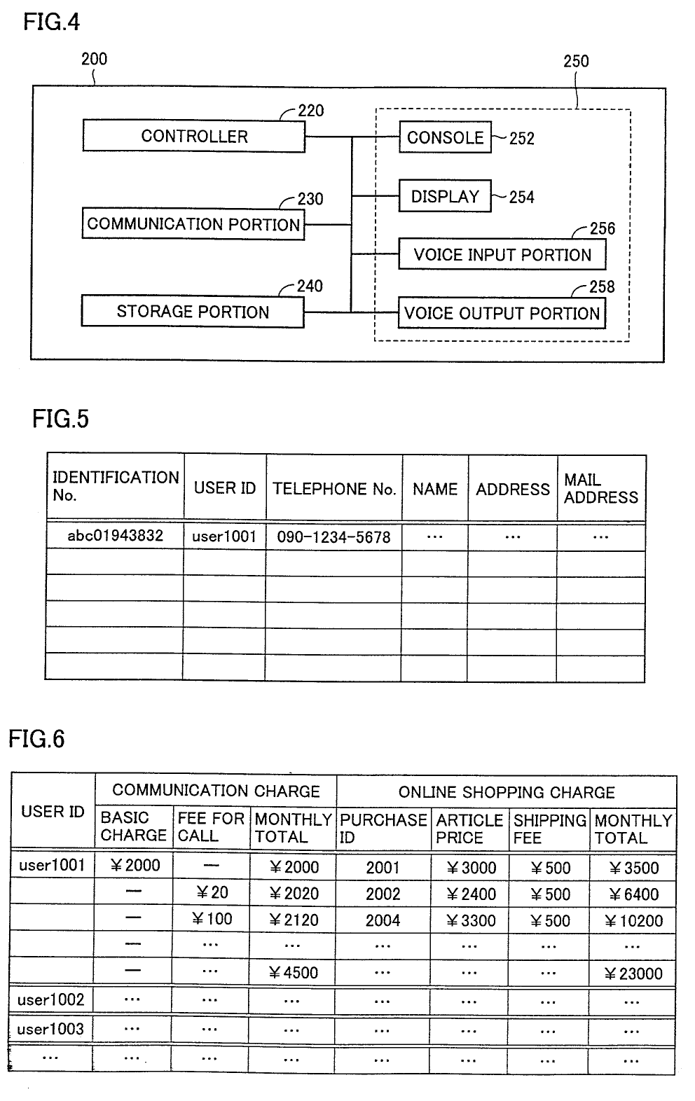

Referring to FIG. 4, user's mobile telephone 200 includes a controller 220 for controlling the whole of mobile telephone 200, a communication portion 230 for communication with other telephone sets and computers, a storage portion 240 for storing a program to be executed by controller 220, intermediate data produced by execution of the program and electronic mails received via communication portion 230, and an I/O portion 250.

I/O portion 250 includes a console 252 including a ten-key pad, a display 254 including an LCD (Liquid Crystal Display) for displaying the telephone number entered through console 252 as well as received electronic mails and others, a voice input portion 256 for inputting voice via a microphone and a voice output portion 258 formed of a loudspeaker outputting voice. Through console 252, the user of mobile telephone 200 can enter the telephone number of another telephone set, a request for displaying a received electronic mail, can prepare an electronic mail and can enter a request for sending the prepared electronic mail.

Mobile telephone 200 stores in storage portion 240 the identification information for discriminating the hardware itself of mobile telephone 200 from other hardware. This identification information was stored during manufacturing of mobile telephone 200, and is unrewritable.

The user of mobile telephone 200 has already signed a contract for a subscriber line with the communication company of the mobile telephone. When signing the contract, the communication company of the mobile telephone defines a correspondence between the identification information of the mobile telephone and the telephone number of the mobile telephone in the personal information. After signing the contract, the user can use mobile telephone 200. The user pays a basic charge for use of the mobile telephone line and a charge, which is calculated based on the time and distance of the telephone call, to the communication company of the mobile telephone.

Server 100 is managed by the communication company of the mobile telephone, with which the user signed for the line. As will be described later, server 100 stores the name and address of the user in the personal information, which are brought into correspondence with the identification information. The address in the personal information is set as the destination of the article in the online shopping system.

In the following description, the mobile telephone will be described as the user's terminal, although not restricted thereto. The user's terminal may be a desk telephone or the like.

Referring to FIG. 5, description will be given on the user database, which is stored in fixed disk 124 of server 100 according to this embodiment. As shown in FIG. 5, the user database contains, for each identification number of mobile telephone 200, the user ID (Identification), mobile telephone number, name, address and mail address for sending data to mobile telephone 200. The user ID is the information for specifying the user utilizing the online shopping in this online shopping system. The name and address are the same as those provided by the user when signing a contract for the mobile telephone line of the communication company. The identification number is information for identifying the hardware of mobile telephone 200, and is unrewritable.

Referring to FIG. 6, description will now be given on the accounting database stored in fixed disk 120 of server 100. As shown in FIG. 6, the accounting database contains the communication charge and the online shopping charge for each user ID. The communication charge contains the basic charge for use of the communication line and the telephone call charge. The online shopping charge contains the article price and the shipping fee for each purchase ID. The total communication charge and the total shopping charge in each month are stored.

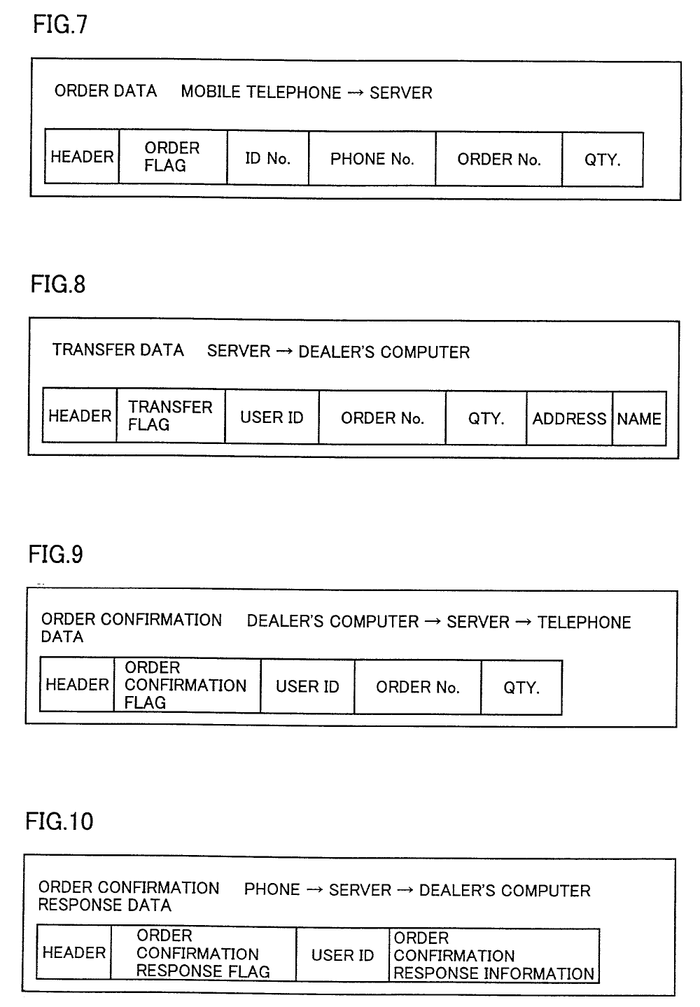

Referring to FIG. 7, description will be given on the order data, which is sent from mobile telephone 200 to server 100. As shown in FIG. 7, the order data includes a header, an ordering flag indicating that the data is the order data, the identification number, the mobile telephone number, the ordered article number and the ordered quantity. When the user requests mobile telephone 200 to send the article number for purchase and the quantity, mobile telephone 200 sends the order data to server 100.

Referring to FIG. 8, description will now be given on transfer data, which is sent from server 100 to computer 300 of the online shopping dealer. As shown in FIG. 8, the transfer data includes a header, a transfer flag indicating that this data is the transfer data, the user ID, the ordered article number, the ordered quantity, the address and the name. When server 100 receives the order data (FIG. 7), server 100 retrieves the address and name of the user from the user database (FIG. 5), and produces the transfer data.

Referring to FIG. 9, description will be given on the order confirmation data, which is sent from computer 300 of the online shopping dealer to server 100, and is sent from server 100 to mobile telephone 200. As shown in FIG. 9, the order confirmation data includes a header, an order confirmation flag indicating that the data is the order confirmation data, the user ID, the ordered article number and the ordered quantity. When computer 300 of the online shopping dealer receives the transfer data (FIG. 8), computer 300 sends the order confirmation data to server 100. Server 100 sends this order confirmation data to mobile telephone 200.

Referring to FIG. 10, description will be given on the order confirmation response data, which is sent from mobile telephone 200 to server 100, and is sent from server 100 to computer 300 of the online shopping dealer. As shown in FIG. 10, the order confirmation response data includes a header, an order confirmation response flag indicating that the data is the order confirmation response data, the user ID and order confirmation response information. Mobile telephone 200 which received the order confirmation data (FIG. 9) displays on its display 254 the ordered article number and the ordered quantity. When the user of mobile telephone 200 determines that the displayed contents are correct, the user requests mobile telephone 200 to send the order confirmation response data. Mobile telephone 200 sends the order confirmation response data to computer 300 of the online shopping dealer.

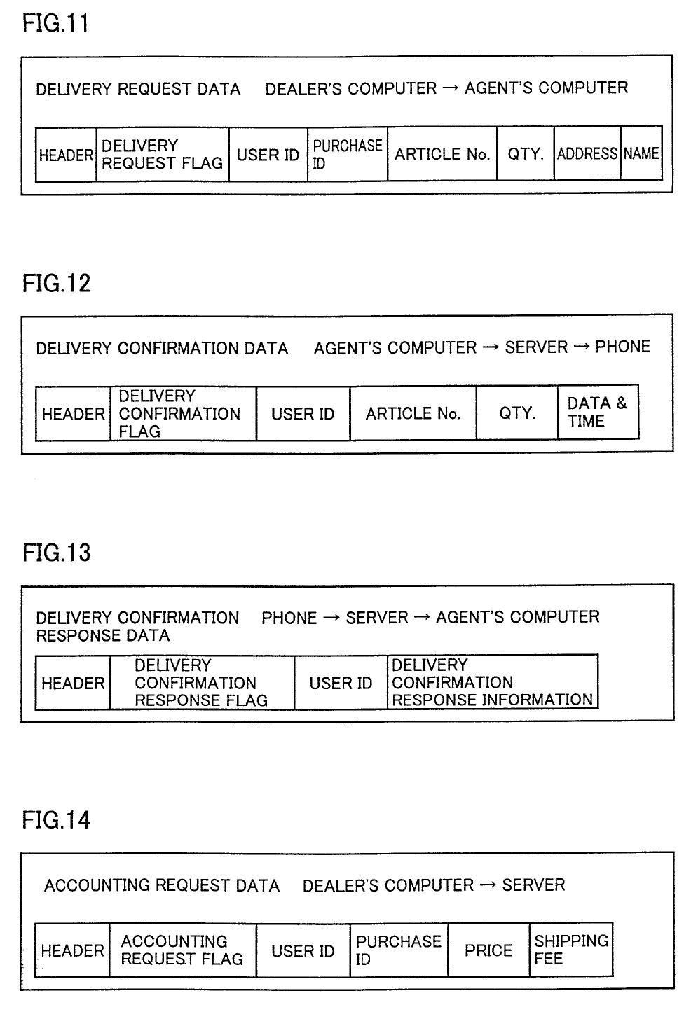

Referring to FIG. 11, description will be given on the delivery request data, which is sent from computer 300 of the online shopping dealer to computer 400 of the shipping agent. As shown in FIG. 11, the delivery request data includes a header, a delivery request flag indicating that this data is the delivery request data, the user ID, the purchase ID, the ordered article number, the ordered quantity, the address and the name. Computer 300 of the online shopping dealer which received the transfer data (FIG. 8) sends this delivery request data to computer 400 of the shipping agent.

Referring to FIG. 12, description will be given on the delivery confirmation data which is sent from computer 400 of the shipping agent to server 100, and is sent from server 100 to mobile telephone 200. As shown in FIG. 12, the delivery confirmation data includes a header, a delivery confirmation flag indicating that the data is the delivery confirmation data, the user ID, the ordered article number, the ordered quantity and the delivery date and time. Computer 400 of the shipping agent sends this delivery confirmation data to mobile telephone 200 for notifying the user of the scheduled delivery date and time.

Referring to FIG. 13, description will be given on the delivery confirmation response data which is sent from mobile telephone 200 to server 100, and is sent from server 100 to computer 400 of the shipping agent. As shown in FIG. 13, the delivery confirmation response data includes a header, a delivery confirmation response flag indicating that the data is the delivery confirmation response data, the user ID and delivery confirmation response information. Mobile telephone 200 which has received the delivery confirmation data (FIG. 12) displays the scheduled delivery date and time on its display 254. When the user of mobile telephone 200 confirms the displayed contents, the user requests mobile telephone 200 to send the delivery confirmation response data to server 100. Server 100 sends this delivery confirmation response data to computer 400 of the shipping agent.

Referring to FIG. 14, description will be given on the accounting request data which is sent from computer 300 of the online shopping dealer to server 100. As shown in FIG. 14, the accounting request data includes a header, an accounting request flag indicating that the data is the accounting request data, the user ID, the purchase ID, the price of article and the shipping fee.

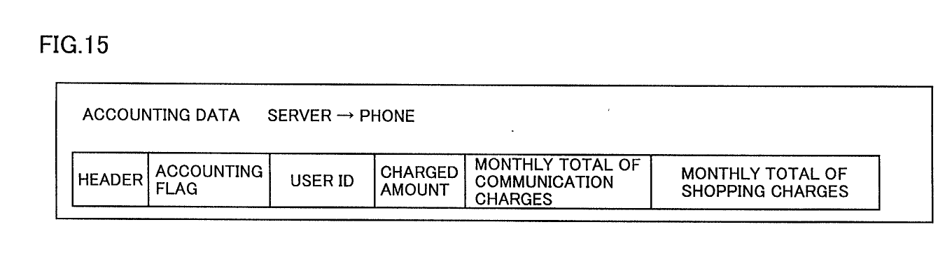

Referring to FIG. 15, description will be given on the accounting data which is sent from server 100 to mobile telephone 200. As shown in FIG. 15, the accounting data includes a header, an accounting flag indicating that the data is the accounting data, the user ID, the charged amount, a cumulative amount of communication charges per month and a cumulative amount of online shopping charges per month. Server 100 sends the accounting data to mobile telephone 200 every month.

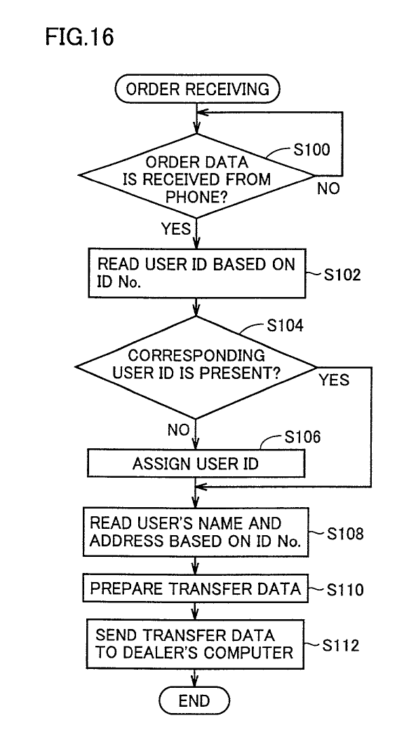

Referring to FIG. 16, the program executed by server 100 according to this embodiment has the following control structure in connection with the order processing.

In a step (which may also be expressed simply as “S” hereinafter) 100, CPU 120 of server 100 determines whether the order data (FIG. 7) is received from mobile telephone 200. When the order data is received from mobile telephone 200 (YES in S100), the processing moves to S102. If not (NO in S100), the processing returns to S100 for waiting for reception of the order data from mobile telephone 200.

In S102, CPU 120 reads out the user ID from the user database (FIG. 5) based on the identification number included in the received order data. In S104, CPU 120 determines whether the user ID corresponding to the ID number is registered in the user database. If the user ID is in the user database (YES in S104), the processing moves to S108. If not (NO in S104), the processing moves to S106.

In S106, CPU 120 assigns the user ID to the user. In this operation, CPU 120 assigns the user ID allowing specification or identification of the user who utilizes the online shopping system.

In S108, CPU 120 reads out the name and address of the user from the user database (FIG. 5) based on the identification number. In S110, CPU 120 prepares the transfer data including the user's name and address thus read.

In S112, CPU 120 sends the transfer data (FIG. 8) prepared in S110 to computer 300 of the online shopping dealer.

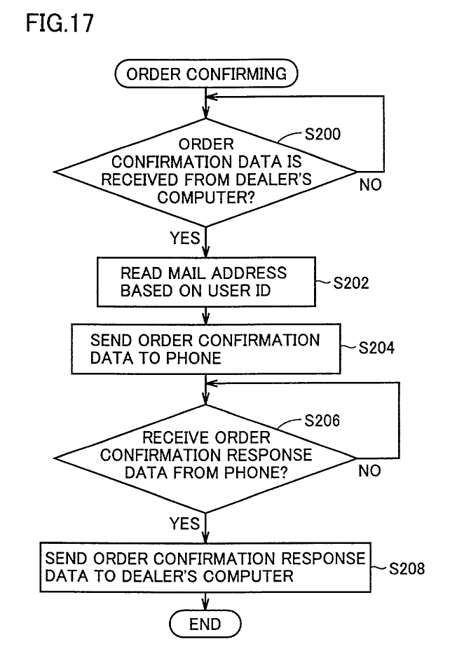

Referring to FIG. 17, the program executed by server 100 has the following control structure in connection with the order confirmation processing.

In S200, CPU 120 determines whether the order confirmation data (FIG. 9) is received from computer 300 of the online shopping dealer. When the order confirmation data is received (YES in S200), the processing moves to S202. If not (NO in S200), the processing returns to S200 for waiting for reception of the order information data sent from computer 300.

In S202, CPU 120 reads out the mail address of the user from the user database (FIG. 5) based on the user ID contained in the order confirmation data.

In S204, CPU 120 sends the order confirmation data (FIG. 9) to the mail address read in S202.

In S206, CPU 120 determines whether the order confirmation response data (FIG. 10) is received from mobile telephone 200 or not. When the order confirmation response data is received (YES in S206), the processing moves to S208. If not (NO in S206), the processing returns to S206 for waiting for the reception of the order confirmation response data from mobile telephone 200.

In S208, CPU 120 sends the order confirmation response data (FIG. 10) to computer 300 of the online shopping dealer.

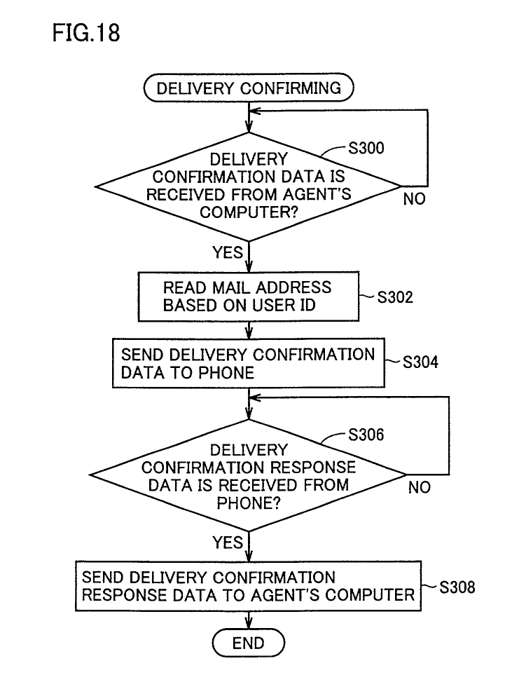

Referring to FIG. 18, the program executed by server 100 has the following control in connection with the delivery confirmation processing.

In S300, CPU 120 determines whether the delivery confirmation data (FIG. 12) is received from computer 400 of the shipping agent or not. If the delivery confirmation data is received from computer 400 of the shipping agent (YES in S300), the processing moves to S302. If not (NO in S300), the processing returns to S300 for waiting for reception of the delivery confirmation data from computer 400 of the shipping agent.

In S302, CPU 120 reads out the mail address of the user from the user database (FIG. 5) based on the user ID included in the delivery confirmation data. In S304, CPU 120 sends the delivery confirmation data (FIG. 12) to the mail address thus read.

In S306, CPU 120 determines whether the delivery confirmation response data (FIG. 13) is received from mobile telephone 200. When the delivery confirmation response data is received (YES in S306), the processing moves to S308. If not (NO in S306), the processing returns to S306 for waiting for reception of the delivery confirmation response data.

In S308, CPU 120 sends the delivery confirmation response data, which was received in S306, to computer 400 of the shipping agent.

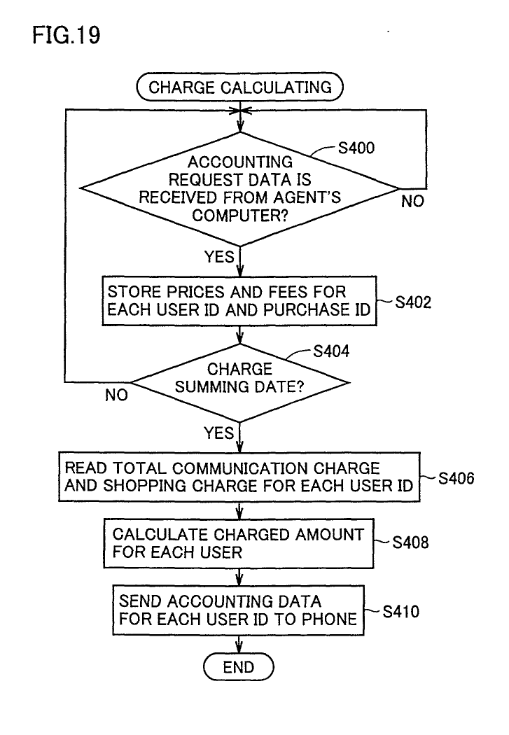

Referring to FIG. 19, the program executed by server 100 has the following control structure in connection with the charge calculating processing.

In S400, CPU 120 determines whether the accounting request data (FIG. 14) is received from computer 300 of the online shopping dealer. If the accounting request data is received (YES in S400), the processing moves to S402. If the accounting request data is not received (NO in S400), the processing returns to S400 for waiting for reception of the delivery request data.

In S402, CPU 120 stores the cumulative amounts of the article prices and shipping fees for each user ID and each purchase ID in the accounting database (FIG. 6).

In S404, CPU 120 determines whether the current date and time reach the charge summing date and time. The charge summing date and time are already set, e.g., to the end data of each month. If the current date and time have reached the charge summing date and time (YES in S404), the processing moves to S406. If not (NO in S404), the processing returns to S400, and the accounting database shown in FIG. 6 is updated every time the accounting request data is received from computer 300 of the online shopping dealer.

In S406, CPU 120 reads out the cumulative amount of communication charges and the cumulative amount of shopping charges for each user ID from the accounting database (FIG. 6). In S408, CPU 120 calculates the charge for each user ID. The charge calculated in S408 is a sum of the cumulative amount of the communication charges per month and the cumulative amount of the shopping charges per month. In S410, CPU 120 sends the accounting data (FIG. 15) to the mail address based on the user ID.

Based on the architecture and flow charts described above, operations of the online shopping system are performed as follows.

[Ordering Operation]

The user of mobile telephone 200 signs a contract for a subscriber line of mobile telephone 200 with the communication company of the mobile telephone. When signing the contract for the subscriber line, the user provides his/her name and address. The mobile telephone communication company stores the name and address of the user provided thereto as well as identification number, telephone number of mobile telephone 200 and the correspondence between them. In addition to the above, the mail address is stored, and the user database (FIG. 5) is prepared.

The user of mobile telephone 200 views a catalog or the like for online shopping, and determines the article number of the article, which the user intends to purchase. The user of mobile telephone 200 enters the determined article number and the quantity via console 252 of mobile telephone 200. The user of mobile telephone 200 requests via console 252 the sending of the order data to server 100. Mobile telephone 200 reads out the identification number stored in storing portion 240, and sends the order data (FIG. 7) including the identification number and the telephone number to server 100.

When server 100 receives the order data (FIG. 7) from mobile telephone 200 (YES in S100), server 100 reads out the user ID from the user database (FIG. 5) based on the identification number included in the received order database. If the user in question is already registered (YES in S104), the name and address of the user, who sent the order data, are read out from the user database (FIG. 5) based on the identification number (S108). Server 100 prepares transfer data (FIG. 8) based on the read name and address of the user (S110), and sends the transfer data (FIG. 8) to computer 300 of the online shopping dealer (S112).

[Order Confirming Operation]

Computer 300 of the online shopping dealer, which has received the transfer data (FIG. 8) from server 100, sends the order confirmation data (FIG. 9) to server 100. When server 100 receives the order confirmation data (YES in S200), the mail address of the user is read out based on the user ID included in the received order confirmation data (S202). Server 100 sends the order confirmation data (FIG. 9) to mobile telephone 200 based on the read mail address.

The user of mobile telephone 200, who received the order confirmation data (FIG. 9), confirms the contents of the order sent by himself/herself from the contents displayed on display 254 of mobile telephone 200. If the displayed contents are correct, the user enters into mobile telephone 200 the information indicating that the contents of the order confirmation data are correct. The user requests mobile telephone 200 to send the order confirmation data (FIG. 10). Mobile telephone 200 sends the order confirmation response data to server 100.

When server 100 receives the order confirmation response data (FIG. 10) from mobile telephone 200 (YES in S206), it sends the received confirmation response data to computer 300 of the online shopping dealer.

[Delivery Confirming Operation]

Computer 300 of the online shopping dealer, which received the transfer data (FIG. 8) from server 100, prepares the delivery request data (FIG. 11) based on the ordered article number, quantity, address and name included in the transfer data. Computer 300 of the online shopping dealer sends this delivery request data to computer 400 of the shipping agent.

Computer 400 of the shipping agent, which received the delivery request data (FIG. 11) from server 100, sends the delivery confirmation data (FIG. 12) to server 100. When server 100 receives the delivery confirmation data from computer 400 of the shipping agent (YES in S300), it reads out the mail address of the user based on the user ID included in the received data (S302). Server 100 sends the delivery confirmation data (FIG. 12) to the read address.

In mobile telephone 200 which has received the delivery confirmation data (FIG. 12), the scheduled delivery date and time are displayed on display 254 of mobile telephone 200. The user of mobile telephone 200 recognizes the scheduled delivery date and time thus displayed, and enters, as the delivery confirmation response information, the data to the effect that the user accepts the scheduled delivery date and time. The user of mobile telephone 200 requests the sending of delivery confirmation response data (FIG. 13). When server 100 receives the delivery confirmation response data from mobile telephone 200 (YES in S306), it sends the received delivery confirmation response data to computer 400 of the shipping agent (S308).

[Charge Calculating Operation]

Every time server 100 receives the accounting request data (FIG. 14) from computer 300 of the shipping agent (YES in S400), it stores the cumulative amount of the article prices and shipping fees for each user ID and each purchase ID, and updates the accounting database (FIG. 6).

When the charge summing date arrives (YES in S404), the cumulative amounts of the communication charges and the online shopping charges are read out (S406), and the charged amount which is the sum of these charges is calculated (S408). Server 100 sends the accounting data (FIG. 15) for each user ID to mobile telephone 200 (S410).

According to the online shopping apparatus of the embodiment, the user can place the order for online shopping only by entering the intended article number and the quantity into the mobile telephone, and sending them to server 100. The server, which received the order data, retrieves the address and name of the user from the database based on the unrewritable identification number, which allows identification of the hardware itself of mobile telephone 200. The address and name of the user thus retrieved are sent to computer 300 of the online shopping dealer. Computer 300 of the online shopping dealer requests the delivery of the ordered article to computer 400 of the shipping agent. Accordingly, the user information is retrieved based on the unrewritable identification information, which specifies the hardware itself of mobile telephone. Therefore, it is possible to provide the online shopping system, which allows easy ordering of the articles for online shopping without abuse and misuse by third parties.

Instead of sending the accounting data through the electronic mail in the foregoing S410, the accounting data may be sent via postal mail. Also, in addition to the sending of the accounting data via the electronic mail, the accounting data may be sent via the postal mail.

### Second Embodiment

An online shopping system of a second embodiment performs order receiving processing different from the order receiving processing of the first embodiment. Hardware architecture and flowcharts other than above are the same as those of the first embodiment. Accordingly, description of them is not repeated here.

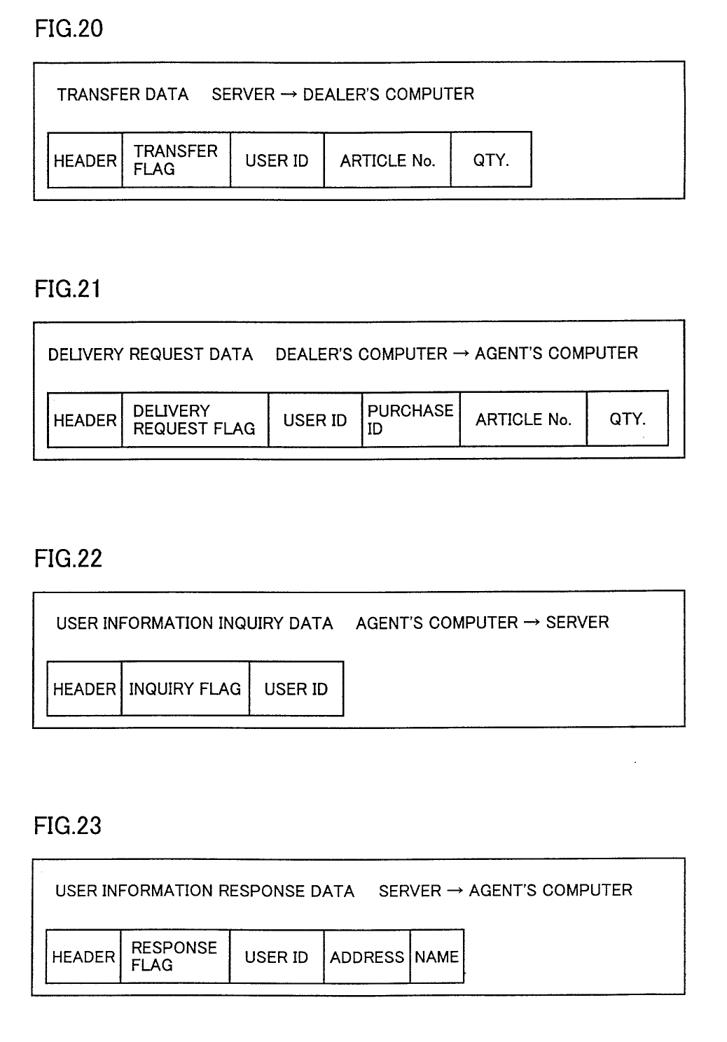

Referring to FIG. 20, description will be given on the transfer data sent from server 100 of this embodiment to computer 300 of the online shopping dealer. As shown in FIG. 20, the transfer data includes a header, a transfer flag indicating that the data is transfer data, a user ID, an ordered article number and a quantity. The transfer data of this embodiment does not include the address and name of the user in contrast to the transfer data of the first embodiment.

Referring to FIG. 21, description will be given on the delivery request data, which is sent from computer 300 of the online shopping dealer to computer 400 of the shipping agent. As shown in FIG. 21, the delivery request data includes a header, a delivery request flag indicating that the data is delivery request data, a user ID, a purchase ID, an ordered article number and a quantity. The delivery request data of this embodiment does not include the name and address of the user in contrast to the delivery request data of the first embodiment.

Referring to FIG. 22, description will be given on the user information inquiry data, which is sent from computer 400 of the shipping agent to server 100. As shown in FIG. 22, the user information inquiry data includes a header, a flag indicating that the data is inquiry data and a user ID. Computer 400 of the shipping agent which received the delivery request data (FIG. 21) sends the user information inquiry data to server 100.

Referring to FIG. 23, description will be given on the user information response data sent from server 100 to computer 400 of the shipping agent. As shown in FIG. 23, the user information response data includes a header, a response flag indicating that the data is response data, a user ID, an address and a name. Server 100 which receives the user information inquiry data (FIG. 22) sends the user information response data to computer 400 of the shipping agent.

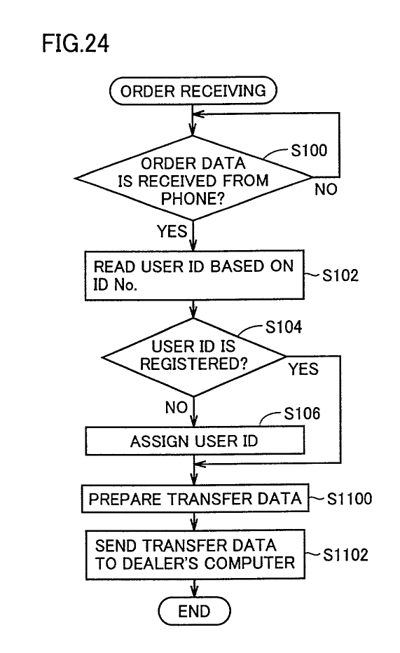

Referring to FIG. 24, the program executed by server 100 of this embodiment has the following control structure in connection with the order receiving processing. In the processing shown in FIG. 24, steps of the same processing as those of the first embodiment shown in FIG. 16 bear the same step numbers. Therefore, description thereof is not repeated here.

When server 100 receives the order data (FIG. 7) from mobile telephone 200, CPU 120 of server 100 assigns the user ID (S106). In S1100, CPU 120 prepares transfer data (FIG. 20). The transfer data thus prepared do not include the address and name of the user. In S1102, CPU 120 sends the transfer data thus prepared to computer 300 of the online shopping dealer.

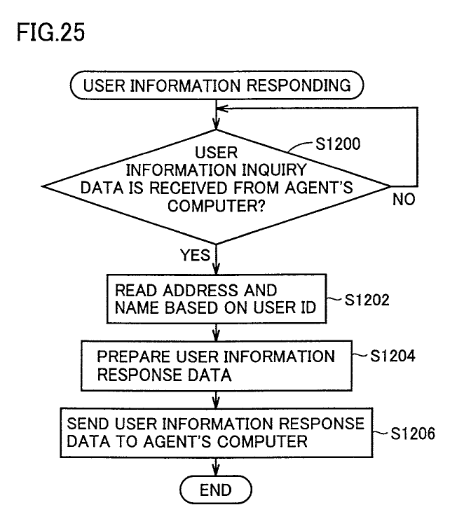

Referring to FIG. 25, the program executed by server 100 has the following control architecture in connection with the user information response processing.

In S1200, CPU 120 determines whether the user information inquiry data (FIG. 22) is received from computer 400 of the shipping agent. When the user information inquiry data is received (YES in S1200), the processing moves to S1202. If not (NO in S1200), the processing returns to S1200 for waiting for the reception of the user information inquiry data.

In S1202, CPU 120 reads out the address and name of the user from the user data base (FIG. 5) based on the user ID included in the received user information inquiry data. In S1204, CPU 120 prepares the user information response data (FIG. 23) based on the read address and name of the user. In S1206, CPU 120 sends the user information response data thus prepared to computer 400 of the shipping agent.

Based on the architecture and flowchart described above, operations of the online shopping system are performed as follows.

[Ordering Operation]

When the user of mobile telephone 200 enters the ordered article number and the quantity, and requests the sending of the order data to server 100, server 100 receives the data (YES in S100). The user ID is read out based on the identification number included in the order data (S102). Transfer data (FIG. 20), which includes the user ID but does not include the address and name of the user, is prepared (S1100), and is sent to computer 300 of the online shopping dealer (S1102).

[User Information Responding Operation]

Computer 300 of the online shopping dealer, which receives transfer data (FIG. 20) including the user ID but not including the address and name of the user, prepares the delivery request data (FIG. 21) based on the received transfer data. Computer 300 of the online shopping dealer sends the delivery request data thus prepared to computer 400 of the shipping agent.

Computer 400 of the shipping agent, which received the delivery request data (FIG. 21) from computer 300 of the online shopping dealer, prepares the user information inquiry data (FIG. 22) based on the user ID included in the received delivery request data. Computer 400 of the shipping agent sends the user information inquiry data thus prepared to server 100.

When server 100 receives the user information inquiry data from computer 400 of the shipping agent (YES in S1200), the address and name of the user are retrieved from the user database (FIG. 5) based on the user ID included in the received data (S1202). Server 100 prepares the user information response data (FIG. 23) based on the retrieved address and name of the user (S1204). Server 100 sends the prepared user information response data to computer 400 of the shipping agent (S1206).

According to the online shopping system of the embodiment, as described above, the transfer data sent from the server to the computer of the online shopping dealer does not include the address and name of the user, but includes only the user ID. The online shopping dealer cannot identify the address and name of the user based on only the user ID. Meanwhile, the computer of the shipping agent, which received the delivery request data from the computer of the online shopping dealer, inquires of the server the address and name of the user based on the user ID. The computer of the shipping agent delivers the ordered article to the designated address based on the user's address and name sent from the server as well as the ordered article number and quantity sent from the computer of the online shopping dealer. As a result, it is possible to provide the online shopping system, which can prevent leakage of personal information such as an address and a name, and allows easy placement of an order for the online shopping.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An online shopping apparatus comprising:
a communication circuit that communicates with a user's terminal and a terminal of an online shopping dealer, said user's terminal storing unrewritable identification information for identifying the user's terminal itself, said user's terminal reading out said identification information, and sending said identification information and article information representing an article selected for purchase to said online shopping apparatus when a user enters said article information;
a storage circuit that stores in advance said identification information, and stores in advance data indicative of a name of the user and data indicative of a destination designated by said user both corresponding to said identification information;
a receiving circuit connected to said communication circuit that receives said article information and said identification information from said user's terminal;
a retrieving circuit connected to said receiving circuit and said storage circuit that retrieves said stored data corresponding to said received identification information;
a producing circuit connected to said retrieving circuit that produces the user's information for specifying said user's name and said designation based on said retrieved data; and
a sending circuit connected to said communication circuit and said producing circuit that sends said article information and said produced user's information to the terminal of said online shopping dealer.

2. The online shopping apparatus according to claim 1, further comprising:
a computing circuit that obtains a charge of communication to said user's terminal;
a price storing circuit that stores data representing prices of said articles corresponding to the articles; and
a calculating circuit connected to said computing circuit and said price storing circuit that adds the price of the article selected by said user to said communication charge, and calculates a sum of money charged to said user.

3. The online shopping apparatus according to claim 1, further comprising:
a confirmation receiving circuit connected to said communication circuit that receives order confirmation information from the terminal of said online shopping dealer; and
a confirmation sending circuit connected to said communication circuit that sends said order confirmation information to said user's terminal.

4. The online shopping apparatus according to claim 1, further comprising:
a shipping agent communication circuit that communicates with a terminal of a shipping agent delivering the article to the user,
said user information being information for specifying said retrieved user's name and destination, and expressing said user's name and destination in the form unrecognizable by said online shopping dealer and said shipping agent,
said terminal of the online shopping dealer sending said article information and said user information to said terminal of the shipping agent, said terminal of the shipping agent sending user inquiry information including said user information to said online shopping apparatus for inquiring said retrieved user's name and destination; and
a user information sending circuit connected to said shipping agent communication circuit that sends the data indicating the name of the user and specified by said user information as well as the data indicating the destination and specified by said user information to said terminal of the shipping agent in response to the reception of said user inquiry information.

5. The online shopping apparatus according to claim 4, further comprising:
a schedule receiving circuit connected to said shipping agent communication circuit that receives delivery schedule information from said terminal of the shipping agent; and
a schedule sending circuit connected to said communication circuit that sends said delivery schedule information to said user's terminal.

6. An online shopping apparatus comprising:
communication means for communicating with a user's terminal and a terminal of an online shopping dealer, said user's terminal storing unrewritable identification information for identifying the user's terminal itself, said user's terminal reading out said identification information, and sending said identification information and article information representing an article selected for purchase to said online shopping apparatus when a user enters said article information;
storage means for storing in advance said identification information and storing in advance data indicative of a name of the user and data indicative of a destination designated by said user both corresponding to said identification information;
receiving means connected to said communication means for receiving said article information and said identification information from said user's terminal;
retrieving means connected to said receiving means and said storage means for retrieving said stored data corresponding to said received identification information;
producing means connected to said retrieving means for producing the user's information for specifying said user's name and said designation based on said retrieved data; and
sending means connected to said communication means and said producing means for sending said article information and said produced user's information to the terminal of said online shopping dealer.

7. The online shopping apparatus according to claim 6, further comprising:
computing means for obtaining a charge of communication to said user's terminal;
price storing means for storing data representing prices of said articles corresponding to the articles; and
calculating means connected to said computing means and said price storing means for adding the price of the article selected by said user to said communication charge and calculating a sum of money charged to said user.

8. The online shopping apparatus according to claim 6, further comprising:
confirmation receiving means connected to said communication means for receiving order confirmation information from the terminal of said online shopping dealer; and
confirmation sending means connected to said communication means for sending said order confirmation information to said user's terminal.

9. The online shopping apparatus according to claim 6, further comprising:
shipping agent communication means for communication with a terminal of a shipping agent delivering the article to the user,
said user information being information for specifying said retrieved user's name and destination, and expressing said user's name and destination in the form unrecognizable by said online shopping dealer and said shipping agent,
said terminal of the online shopping dealer sending said article information and said user information to said terminal of the shipping agent, said terminal of the shipping agent sending user inquiry information including said user information to said online shopping apparatus for inquiring said retrieved user's name and destination; and
user information sending means connected to said shipping agent communication means for sending the data indicating the name of the user and specified by said user information as well as the data indicating the destination and specified by said user information to said terminal of the shipping agent in response to the reception of said user inquiry information.

10. The online shopping apparatus according to claim 9, further comprising:
schedule receiving means connected to said shipping agent communication means for receiving delivery schedule information from said terminal of the shipping agent; and
schedule sending means connected to said communication means for sending said delivery schedule information to said user's terminal.

11. An online shopping method for use by an online shopping apparatus performing communication between a user's terminal and a terminal of an online shopping dealer, wherein said user's terminal stores unrewritable identification information for identifying the user's terminal itself, said user's terminal reads out said identification information, and sends said identification information and article information representing an article selected for purchase to said online shopping apparatus when a user enters the article information,
said online shopping method comprising the steps of:
preparing in advance said identification information, data representing a user's name and corresponding to said identification information, and data representing a destination designated by said user and corresponding to said identification information;
receiving said article information and said identification information from said user's terminal;
retrieving said data stored corresponding to said received identification information;
preparing user information for specifying said user's name and destination based on said retrieved data; and
sending said article information and said prepared user information to the terminal of said online shopping dealer.

12. The online shopping apparatus according to claim 11, further comprising the steps of:
obtaining by calculation a charge of communication to said user's terminal;
preparing data representing prices of said articles corresponding to the articles; and
calculating a sum of money charged to said user by adding the price of the article selected by said user to said communication charge.

13. The online shopping method according to claim 11, further comprising the steps of:
receiving order confirmation information from the terminal of said online shopping dealer; and
sending said order confirmation information to said user's terminal.

14. The online shopping method according to claim 11, wherein
said online shopping apparatus further makes a communication with a terminal of a shipping agent delivering the article to the user,
said user information is information for specifying said retrieved user's name and destination, and expressing said user's name and destination in the form unrecognizable by said online shopping dealer and said shipping agent,
said terminal of the online shopping dealer sends said article information and said user information to said terminal of the shipping agent, said terminal of the shipping agent sends user inquiry information including said user information to said online shopping apparatus for inquiring said retrieved user's name and destination; and
said online shopping method further comprises the step of sending the data indicating the name of the user and specified by said user information as well as the data indicating the destination and specified by said user information to said terminal of the shipping agent in response to the reception of said user inquiry information.

15. The online shopping method according to claim 14, further comprising the steps of:
receiving delivery schedule information from said terminal of the shipping agent; and
sending said delivery schedule information to said user's terminal.
